(19) United States
(12) Patent Application Publication
(10) Pub. No.: US 2010/0047022 A1
(43) Pub. Date: Feb. 25, 2010

(54) SUBSEA FLOW LINE PLUG REMEDIATION

(75) Inventor: Yves Le Moign, Singapore (SG)

Correspondence Address: SCHLUMBERGER OILFIELD SERVICES, 200 GILLINGHAM LANE, MD 200-9, SUGAR LAND, TX, 77478, US

(73) Assignee: SCHLUMBERGER TECHNOLOGY CORPORATION, Sugar land, TX (US)

(21) Appl. No.: 12/194,562

(22) Filed: Aug. 20, 2008

(51) Int. Cl. B05C 7/08

(52) U.S. Cl. 405/184.1

(57) ABSTRACT

A technique enables removal of a hydrate plug or other similar plug from a deep water flow line. When the existence of a plug in the deep water flow line is determined, a temporary flow line loop is created to enable remedial procedures. The temporary loop can be created by deploying a spoolable compliant guide and connecting the spoolable compliant guide to the deep water flow line. The connection is made in a manner that enables access to both sides of the unwanted plug.

### BACKGROUND

In the oilfield industry, deep water production has become more common. One of the challenges with deep water production is the uncontrolled formation of undesirable hydrate plugs in deep water flow lines. Hydrates are crystalline, ice-like solids formed in oil and gas installations as a result of combined hydrocarbon gases and water in a high pressure, low temperature environment normally not seen in surface or shallow water applications. At times, the hydrates accumulate to form plugs that prevent normal oil and gas production or other operations. Once formed, the hydrate plugs are fairly stable and difficult to eliminate.

A conventional approach to reducing hydrate plugs involves the combination of depressurization on both sides of the plug and methanol injection. This approach requires access from both sides of the plug because single-sided depressurization can result, in sudden, uncontrolled and potentially damaging plug movement. As a result, some subsea oil and gas production flow lines are arranged in permanent loops to provide access to both sides of any potential hydrate plug. The use of permanent flow line loops becomes increasingly uneconomical, however, particularly when used for subsea tie-backs or when used in deeper waters requiring insulated flow lines.

Other approaches also have been attempted or proposed. For example, pipe-in-pipe techniques have been proposed to better isolate the flow lines and thereby prevent formation of hydrate plugs. The use of large quantities of inhibitors also has been used to prevent formation of hydrate plugs. However, these techniques require substantial capital expenditure. Intrusive remediation methods also have been proposed in which tools are inserted in the flow line and driven to close proximity with the plug. However, these methods are difficult to actually implement because of limited access to the flow lines, and because the hydrate plug can be a substantial distance from available access points.

### SUMMARY

In general, the present invention provides a system and method for removing a plug, such as a hydrate plug, from a deep water flow line. The system enables construction of a subsea production installation with a deep water subsea flow line that is not arranged in a permanent loop. If the existence of a plug in the deep water flow line is determined, a temporary flow line loop is created to enable remedial procedures. The temporary loop can be created by deploying a spoolable compliant guide and connecting the spoolable compliant guide to the deep water flow line. The connection is made in a manner that enables, for example, remedial fluid injection and/or pressure control on both sides of the unwanted plug.

### BRIEF DESCRIPTION OF THE DRAWINGS

Certain embodiments of the invention will hereafter be described with reference to the accompanying drawings, wherein like reference numerals denote like elements, and:

FIG. 1 is a schematic illustration of a subsea production installation in which a temporary loop has been formed, according to an embodiment of the present invention;

FIG. 2 is a schematic illustration of a subsea production installation in which a temporary loop has been formed, according to an alternate embodiment of the present invention;

FIG. 3 is a schematic illustration of a subsea production installation in which a temporary loop has been formed, according to an alternate embodiment of the present invention;

FIG. 4 is a cutaway view of a portion of a spoolable compliant guide having coiled tubing deployed along its interior, according to another embodiment of the present invention; and

FIG. 5 is a flow chart illustrating one example of a remediation procedure, according to an embodiment of the present invention.

### DETAILED DESCRIPTION

In the following description, numerous details are set forth to provide an understanding of the present invention. However, it will be understood by those of ordinary skill in the art that the present invention may be practiced without these details and that numerous variations or modifications from the described embodiments may be possible.

The present invention generally relates to a system and method that facilitates removal of plugs, e.g. hydrate plugs, from deep water flow lines in an economical and adaptable manner. A compliant guide, such as a spoolable compliant guide, is temporarily connected to a deep wafer flow line of a subsea installation to create a temporary loop. The spoolable compliant guide can be connected at a location that creates a temporary loop including all or a portion of the deep water flow line. Once the remedial operation is completed, the compliant guide can be disconnected and removed from the subsea installation. Selective formation of the temporary loop is much less expensive than constructing a permanent loop, but still enables implementation of a variety of plug remedial techniques, including conventional techniques. For example, the temporary loop enables controlled depressurization on both sides of the plug and/or methanol injection. The temporary loop enables these and other remedial techniques in subsea fields where the use of single flow lines or tie-back lines would otherwise prevent implementation of such remedial techniques.

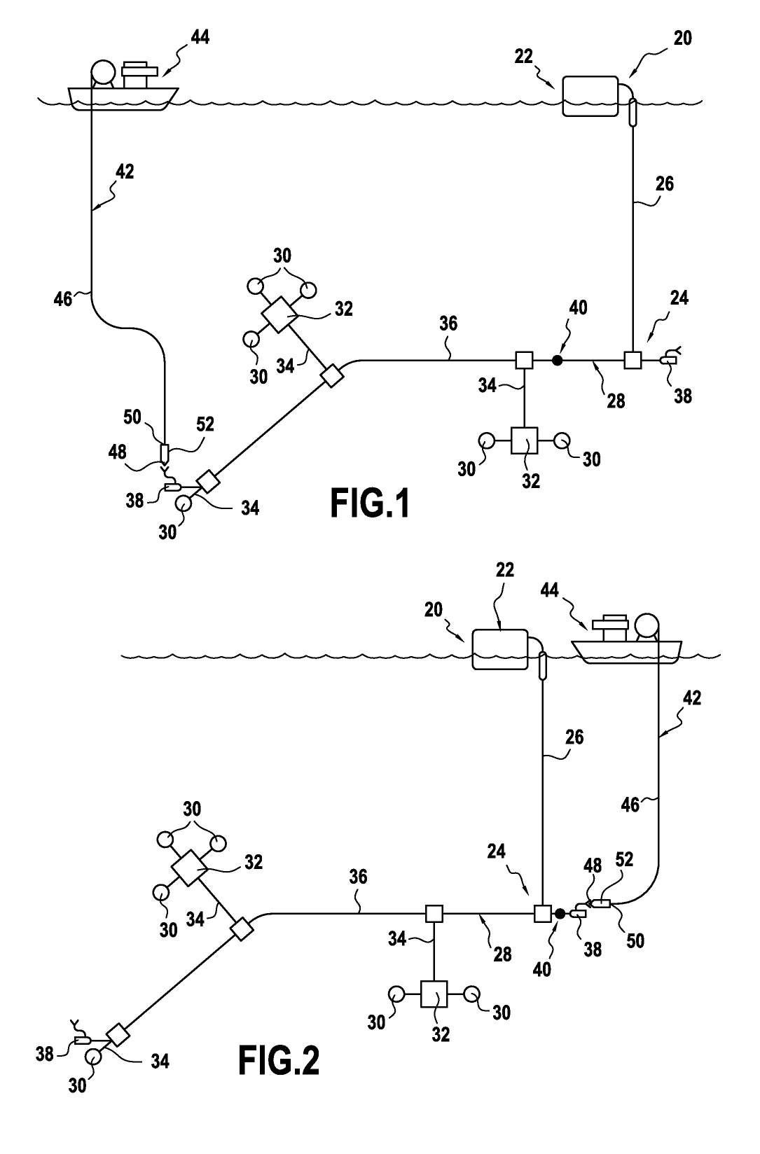

Referring generally to FIG. 1, one embodiment of a remediation system 20 is illustrated. In this embodiment, remediation system 20 comprises a surface production installation 22 and a subsea installation system 24. The surface production installation and the subsea installation system 24 are coupled together by, for example, a riser system 26. The riser system 26 may comprise a rigid riser system or a flexible riser system that provides a flow passage between a deep water flow line 28 of subsea installation system 24 and the surface production installation 22. The surface production installation 22 may comprise any suitable installation, such as a platform or a floating, production, storage and offloading vessel.

In the example illustrated, deep water flow line 28 drains the production of one or more wells 30. As illustrated, several wells 30 can be connected in fluid communication with deep water flow line 28. The wells 30 are either directly tied to deep water flow line 28, or the wells 30 are clustered around manifolds 32 that commingle the production of several wells. The deep water flow line 28 may comprise a plurality of jumpers 34 that provide fluid flow passages between wells 30 and a primary flow line 36 of deep water flow line 28. The jumpers 34 also can provide flow passages between manifolds 32 and the primary flow line 36. Depending on the application, jumpers 34 can be constructed in a variety of forms, including rigid jumpers and flexible jumpers.

The deep water flow line 28 may be constructed with pipe line termination or end termination units 38. The end termination units 38 are designed to allow the insertion and removal of pigs from the pipeline. Pigs are tools that can be propelled by fluid flow along the interior of the flow lines for a variety of purposes, including cleaning and monitoring of the flow lines.

Deep water flow lines are susceptible to the formation of plugs, e.g. hydrate plugs, which can form in a variety of locations throughout the subsea installation system 24 once certain conditions are present. For the purpose of description, a plug 40, e.g. a hydrate plug, is illustrated schematically in FIG. 1. In many applications, the plugs tend to form at well heads, in jumpers 34, in manifolds 32, and at other locations in the flow lines, particularly where restrictions are present. The plugs also can form along primary flow line 36 or throughout deep water flow line 28 and riser system 26. Once the plug is formed, a variety of known techniques/processes can be used to generally locate the position and extent of the plug, although it is not necessary to know the exact location or extent of the plug to utilize the plug remediation system described herein.

Generally, the plug remediation technique involves creation of a temporary loop to facilitate removal of the plug. The temporary loop can be formed when needed to include the entire deep water flow line 28 or portions of the deep water flow line. The temporary loop is formed and connected so as to create access to both sides of plug 40.

In the embodiment illustrated, the temporary loop is formed by deploying a compliant guides such as a spoolable compliant guide 42, between the subsea installation system 24 and a surface, intervention vessel 44. Accordingly, the temporary loop extends from surface production installation 22 to surface intervention vessel 44 and includes riser system 26, deep water flow line 28 (in whole or in part), and spoolable compliant guide 42. The spoolable compliant guide 42 may be supported by a dynamically positioned intervention vessel 44.

The spoolable compliant guide 42 comprises a generally flexible guide member 46 having a hollow interior. The flexibility enables deployment of spoolable compliant guide 42 in a variety of shapes and configurations. However, the spoolable compliant guide 42 also can comprise a variety of other components depending on the specific application, environment, and equipment to which the spoolable compliant guide is connected. For example, spoolable compliant guide 42 comprises a connector 48 selected according to the existing subsea hardware of the subsea installation system 24. The connector 48 can be selected, for example, to enable mating engagement with wellheads, and termination units, and other access point hardware. The spoolable compliant guide creates minimal loads on the subsea equipment and thereby enables use of the original style and type of connectors incorporated into the subsea installation system. The connector 48 also may comprise an interchangeable connector able to facilitate adaptation of the spoolable compliant guide for connection to a variety of different subsea installation connectors.

Depending on the specific application, spoolable compliant guide 42 also can incorporate other components to facilitate a variety of operational procedures. For example, spoolable compliant guide 42 may comprise an isolation mechanism 50 which allows the spoolable compliant guide 42 to be closed off if necessary. Additionally, spoolable compliant guide 42 may comprise an emergency disconnect 52 to facilitate disconnecting the spoolable compliant guide 42 from subsea installation system 24 in the event of, for example, an emergency situation involving the intervention vessel 44. A variety of other components also can be utilized with or incorporated into spoolable compliant guide 42 as needed or desired for specific environments and applications.

In some applications, the temporary flow loop can be described as virtual because it is not necessarily physically closed, although other applications may utilize a physically closed loop. Regardless, the temporary flow loop enables two-sided pressure control, i.e. pressure control on both sides of plug 40. For example, the temporary flow loop enables coordinated two-sided depressurization of the deep water flow line 28 and/or circulation through portions of the deep water flow line on both sides of plug 40. In many applications, the circulation of fluid is from the surface intervention vessel 44 and through spoolable compliant guide 42 towards the surface production installation 22 because the surface production installation is equipped to handle returning fluids.

The spoolable compliant guide 42 can be connected to deep water flow line 28 at a variety of locations depending on the location of plug 40 and the desired remedial treatment. In some applications, for example the spoolable compliant guide 44 is connected to the deep water flow line 28 at a location relatively close to plug 40. The connection of spoolable compliant guide 42 can be accomplished in a variety of ways and at a variety of locations along the subsea installation system 24. As illustrated in FIG. 1, for example, the spoolable compliant guide 42 is connected to the end termination unit 38 on the left side of deep water flow line 28. In this embodiment, the spoolable compliant guide is deployed generally in an S-shape to facilitate a vertical connection onto a specific access point. The access point can be formed for the specific purpose of connecting the spoolable compliant guide or for other purposes, such as installation of a pig loop to carry out a cleaning/sensing operation.

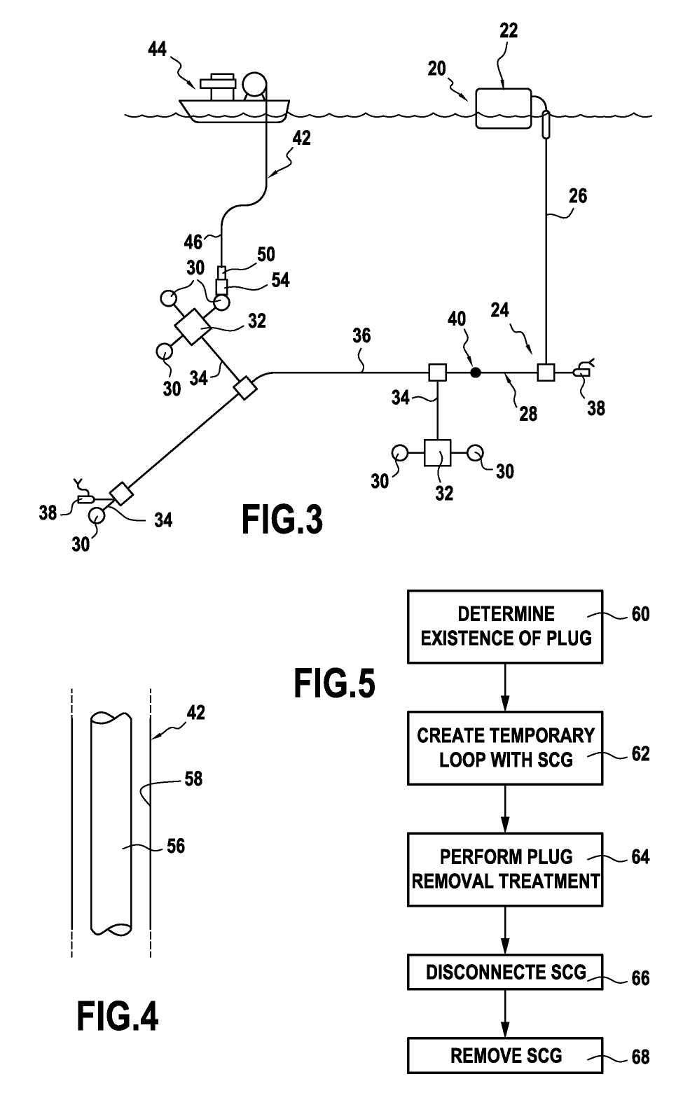

In another application, spoolable compliant guide 42 is deployed generally in a J-shape to facilitate a horizontal connection onto a desired access point, as illustrated in FIG. 2. In the embodiment illustrated in FIG. 2, the spoolable compliant guide 42 is connected to the end termination unit 38 located on the right side of subsea installation system 24. With both vertical and horizontal connections spoolable compliant guide 42 can be connected to end termination units, manifolds, and other subsea installation system components having access points. In FIG. 3, for example, the spoolable compliant guide 42 is connected directly onto a wellhead tree 54.

Once the spoolable compliant guide 42 is connected to the subsea installation system 24 at a desired access point, the well remediation service can begin to remove plug 40. In some applications, a service line 56, such as a coiled tubing string, is inserted along an interior of spoolable compliant guide 42, as illustrated in FIG. 4. The service line 56 is run to a point close to a flow line, well, or other desired component of subsea installation system 24 and used to facilitate hydrate plug or other plug remediation techniques. For example, the service line/coiled tubing 56 can be used to pump inhibiting fluids or similar fluids, e.g. methanol, for displacement in the flow line blocked by plug 40. Initially, return flows of fluid are taken in the spoolable compliant guide along the exterior of service line 56 until fluid in the service line has been displaced by the methanol or other treatment fluid. The connection between the spoolable compliant guide and the deep water flow line 28 can then be opened to allow displacement fluid in the flow line with the methanol or other inhibiting fluid. A suitable valve or other isolation mechanism can be used to selectively open the connection between the spoolable compliant guide 42 and the deep water flow line.

The service line/coiled tubing 56 also can be used to carry a light fluid able to reduce the hydrostatic pressure in both the spoolable compliant guide 42 and the portion of the deep water flow line 28 to which the spoolable compliant guide 42 is connected. By way of example, the light fluid may comprise a gas, such as nitrogen, which is pumped down through the service line 56 to achieve the desired reduction in hydrostatic pressure.

The well remediation service also can/comprise controlling the pressure acting on both sides of plug 40. The pressure control operation is carried out in a coordinated manner between the surface production installation 22 disposed on one side of plug 40 and the surface intervention vessel 44 disposed on the other side of plug 40. In many applications, the pressure control involves balancing the pressure existing on both sides of plug 40, and controlling depressurization. Depressurization on the surface production installation side can be accomplished either with systems already installed on the surface production installation 22, e.g. a gas lift system installed on riser 26, or by adding pressure control units to the surface production installation specifically for remedial operations. For example, a service string similar to service line/coiled tubing 56 could be inserted down through riser 26 to produce a controlled depressurization in a manner similar to that used by a surface intervention vessel, e.g. surface intervention vessel 44.

During the remediation operation, production operations are shut down to prevent any flow of additional hydrocarbons into subsea installation system 24. After plug 40 has been eliminated or suitably reduced, the flow loop can be used to displace the treatment fluid in the flow line with a fluid appropriate for facilitating a controlled restart of normal production operations through the deep water flow line 38. The spoolable compliant guide 42 can then be disconnected and removed by retrieving the spoolable compliant guide to surface intervention vessel 44.

Referring generally to FIG. 5, a flow chart is provided to illustrate one example of a general sequence of events in carrying out a plug remediation procedure. Initially, the existence of a plug, e.g. a hydrate plug, is determined, as illustrated by block 60. Subsequently, a temporary or virtual loop is created with a spoolable compliant guide, as illustrated by block 62. Once the spoolable compliant guide is appropriately connected to the subsea installation system 24 on an opposite side of plug 40, the plug removal treatment can be performed, as illustrated by block 64. In at least some applications, performance of the plug removal treatment involves deploying coiled tubing or another type of service string 56 through the interior of spoolable compliant guide 42. Upon successfully performing the plug removal treatment, the production operations can be restarted, and spoolable compliant guide 42 can be disconnected, as illustrated by block 66. The temporary flow loop is thus disassembled, and the spoolable compliant guide can be removed to surface intervention vessel 44, as illustrated by block 68.

The remediation system 20 may be formed in a variety of configurations. For example, various types of surface production installations arid surface intervention vessels can be used. Additionally, the subsea installation system can have many configurations that incorporate one or more wells in a variety of patterns and locations. The subsea installation system also can incorporate additional and other types of subsea equipment depending on the environment and production operations performed. Furthermore, the spoolable compliant guide can be used in many configurations and with a variety of connection equipment and other equipment depending on the environment, layout, and equipment of the subsea installation system. Use of the spoolable compliant guide provides an adaptable system that can be connected to the subsea installation system at numerous locations to facilitate plug removal.

Accordingly, although only a few embodiments of the present invention have been described in detail above, those of ordinary skill in the art will readily appreciate that many modifications are possible without materially departing from the teachings of this invention. Such modifications are intended to be included within the scope of this invention as defined in the claims.

What is claimed is:

1. A method for removing a hydrate plug from a deep water flow line, comprising:
determining the existence of a hydrate plug in a deep water flow line;
creating a temporary loop that includes a section of the deep water flow line containing the hydrate plug;
pumping a hydrate plug treatment fluid along the temporary loop to the hydrate plug; and
controlling pressure acting on both sides of the hydrate plug to facilitate a controlled removal of the hydrate plug.

2. The method as recited in claim 1, wherein creating a temporary loop comprises temporarily connecting a spoolable compliant guide to the deep water flow line on an opposite side of the hydrate plug from a surface production installation.

3. The method as recited in claim 1, wherein pumping comprises injecting methanol into the deep water flow line proximate to the hydrate plug.

4. The method as recited in claim 2, wherein pumping comprises injecting methanol through an interior of the spoolable compliant guide.

5. The method as recited in claim 4, further comprising deploying a coiled tubing within the spoolable compliant guide to deliver the methanol along the interior of the spoolable compliant guide.

6. The method as recited in claim 5, further comprising using the coiled tubing to deliver a fluid selected to reduce hydrostatic pressure in the spoolable compliant guide and in the deep water flow line to which the spoolable compliant guide is connected.

7. The method as recited in claim 1, wherein controlling pressure comprises selectively balancing pressure on both sides of the hydrate plug.

8. The method as recited in claim 2, wherein creating comprises coupling the spoolable compliant guide to an end termination unit of the deep water flow line.

9. The method as recited in claim 2, wherein creating comprises coupling the spoolable compliant guide to a wellhead tree of a well coupled to the deep water flow line.

10. A method, comprising:
temporarily coupling a spoolable compliant guide to a deep water flow line on an opposite side of a plug relative to a surface production installation;
removing the plug from the deep water flow line; and
disconnecting and retrieving the spoolable compliant guide.

11. The method as recited in claim 10, wherein temporarily coupling comprises temporarily coupling the spoolable compliant guide to an end termination unit of the deep water flow line.

12. The method as recited in claim 10, wherein temporarily coupling comprises temporarily coupling the spoolable compliant guide to a manifold of the deep water flow line.

13. The method as recited in claim 10, wherein temporarily coupling comprises temporarily coupling the spoolable compliant guide to a wellhead tree.

14. The method as recited in claim 10, wherein removing the plug comprises removing a hydrate plug.

15. The method as recited in claim 10, furthermore comprising, deploying a coiled tubing through the spoolable compliant guide to deliver plug removal fluid.

16. The method as recited in claim 10, further comprising controlling pressure acting on the plug on both sides of the plug.

17. A system, comprising:
a surface production installation;
a deep water flow line in fluid communication with the surface production installation; and
a spoolable compliant guide that may be selectively deployed to the deep water flow line to create a selected, temporary flow line loop of a variety of possible flow line loops to facilitate removal of a plug.

18. The system as recited in claim 17, wherein the deep water flow line comprises at least one end termination unit to which the spoolable compliant guide can be temporarily connected.

19. The system as recited in claim 17, wherein the deep water flow line is connected to a wellhead to which the spoolable compliant guide can be temporarily connected.

20. The system as recited in claim 17, further comprising a coiled tubing deployed within the spoolable compliant guide to deliver plug removal fluids.

21. The system as recited in claim 17, wherein the spoolable compliant guide comprises an isolation mechanism.

22. The system as recited in claim 17, wherein the spoolable compliant guide comprises an emergency disconnect.

23. The system as recited in claim 17, wherein the spoolable compliant guide is deployed in an S-shape to enable a vertical connection with the deep water flow line.

24. The system as recited in claim 17, wherein the spoolable compliant guide is deployed in a J-shape to enable a horizontal connection with the deep water flow line.
